(19) United States
(12) Patent Application Publication
(10) Pub. No.: US 2020/0402110 A1
(43) Pub. Date: Dec. 24, 2020

(54) SYSTEMS AND METHODS FOR DYNAMIC CONTENT PLACEMENT

(71) Applicant: Facebook, Inc., Menlo Park, CA (US)

(72) Inventors: Dan Zhang, Foster City, CA (US); Yuan Liang, Fremont, CA (US); Hongji Yang, Belmont, CA (US); Zhen Li, Cupertino, CA (US); Guangwei Qiu, Fremont, CA (US); Kai Du, San Jose, CA (US); Alexandra Louise Krakaris, Lafayette, CA (US)

(21) Appl. No.: 16/234,143

(22) Filed: Dec. 27, 2018

(51) Int. Cl. G06Q 30/02; G06N 20/00

(52) U.S. Cl. CPC G06Q 30/0269; G06Q 50/01; G06N 20/00

(57) ABSTRACT

Systems, methods, and non-transitory computer-readable media can receive a set of user features associated with a user. An optimal ad load for the user is determined based on the set of user features and one or more machine learning models. The user is provided with one or more advertisements in accordance with the optimal ad load.

### FIELD OF THE INVENTION

The present technology relates to the field of digital content platforms. More particularly, the present technology relates to techniques for automatically and dynamically determining ordering and placement of digital content to be provided to users within a networked computer environment.

### BACKGROUND

Today, people often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others.

### SUMMARY

Various embodiments of the present technology can include systems, methods, and non-transitory computer readable media configured to receive a set of user features associated with a user. An optimal ad load for the user is determined based on the set of user features and one or more machine learning models. The user is provided with one or more advertisements in accordance with the optimal ad load.

In an embodiment, the determining the optimal ad load for the user based on the set of user features and one or more machine learning models comprises selecting an optimal ad load for the user from a plurality of ad loads based on the set of user features and a plurality of machine learning models.

In an embodiment, each machine learning model of the plurality of machine learning models is associated with a respective ad load of the plurality of ad loads.

In an embodiment, the selecting the optimal ad load for the user based on the set of user features and the plurality of machine learning models comprises determining a plurality of predicted user satisfaction scores for the user based on the set of user features and the plurality of machine learning models, and further wherein each predicted user satisfaction score of the plurality of user satisfaction scores is associated with a respective machine learning model of the plurality of machine learning models.

In an embodiment, the selecting the optimal ad load for the user based on the set of user features and the plurality of machine learning models further comprises selecting a first ad load of the plurality of ad loads as the optimal ad load for the user, the first ad load being associated with a first machine learning model of the plurality of machine learning models, and further wherein the first ad load is selected as the optimal ad load for the user based on the first machine learning model having yielded a highest predicted user satisfaction score of the plurality of user satisfaction scores.

In an embodiment, the set of user features comprises demographic information for the user.

In an embodiment, the set of user features comprises historical user-ad interaction information for the user.

In an embodiment, a set of advertisement features is received for one or more candidate advertisements that may be presented to the user.

In an embodiment, the determining the optimal ad load for the user based on the set of user features and one or more machine learning models comprises determining an optimal ad load for the user based on the set of user features, the set of advertisement features, and the one or more machine learning models.

In an embodiment, the set of advertisement features comprise historical click-through rates for the one or more candidate advertisements.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a content provider module, according to an embodiment of the present technology.

FIG. 2 illustrates an example ad placement module, according to an embodiment of the present technology.

FIG. 3 illustrates an example scenario associated with dynamic ad placement, according to an embodiment of the present technology.

FIG. 4 illustrates an example method, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Dynamic Content Placement

People often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to a digital content system or platform, such as a social networking system, for consumption by others.

Digital content platforms, such as a social networking system, may generate revenue by presenting users with advertisements. For example, advertisements may be placed amongst other user-generated content (i.e., “organic content”). Users may find such advertisements to be non-objectionable or even useful. However, if users are presented with too many advertisements, users may become frustrated. Conventional approaches often utilize hard-coded rules for placement of advertisements amongst organic content. However, such hard-coded rules fail to account for the preferences of each individual user. As such, some users may feel that they are being presented with too many advertisements, resulting in user dissatisfaction, while other users may be willing to view even more advertisements, resulting in a loss of potential revenue for the digital content platform. Conventional approaches may not be effective in addressing these and other problems arising in computer technology.

An improved approach rooted in computer technology overcomes the foregoing and other disadvantages associated with conventional approaches specifically arising in the realm of computer technology. In general, one or more machine learning models can be trained to determine optimal advertisement loads (i.e., “ad loads”) for various users. In an embodiment, multiple machine learning models can be trained, with each machine learning model being associated with a particular ad load. Each machine learning model can be trained to receive a set of user features for a particular user, and to output a predicted user satisfaction score. A predicted user satisfaction score determined by a machine learning model can be indicative of a user's predicted satisfaction with a content platform if the user is presented with advertisements in accordance with a particular ad load associated with the machine learning model. For a particular user, predicted user satisfaction scores can be calculated using each machine learning model of the plurality of machine learning models. An optimal ad load can be selected for the user based on the predicted user satisfaction scores. More details relating to the disclosed technology are provided below.

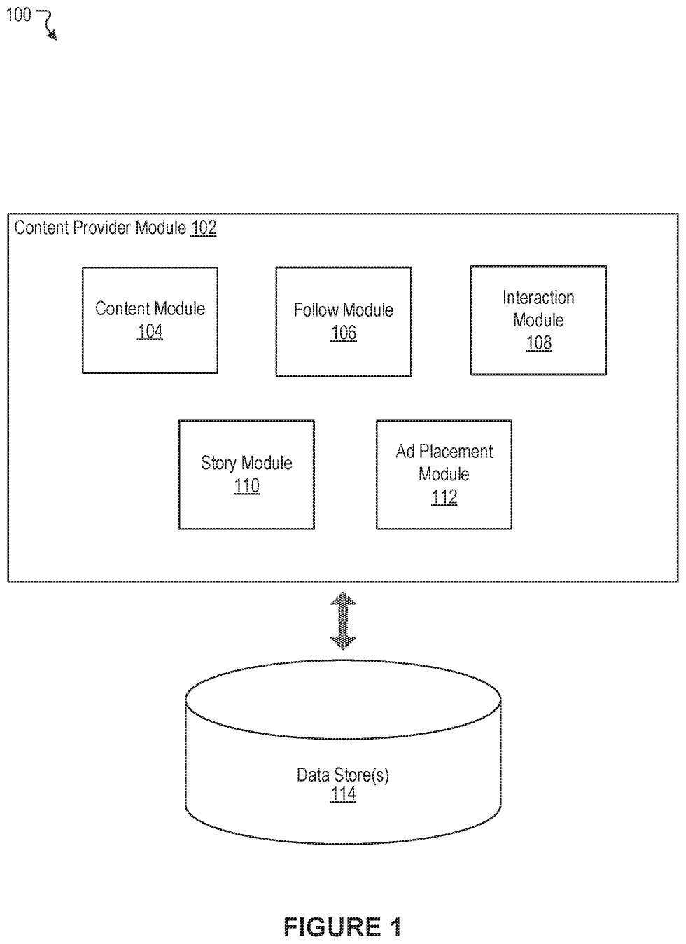

FIG. 1 illustrates an example system 100 including a content provider module 102, according to an embodiment of the present technology. The content provider module 102 can be configured to provide users with access to content posted to a digital content platform, such as a social networking system. Such content can include both organic content, posted by users of the digital content platform, as well as advertisements posted by advertisers on the digital content platform. As shown in the example of FIG. 1, the content provider module 102 can include a content module 104, a follow module 106, an interaction module 108, a story module 110, and an ad placement module 112. In some instances, the example system 100 can include at least one data store 114. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the content provider module 102 can be implemented in any suitable combinations.

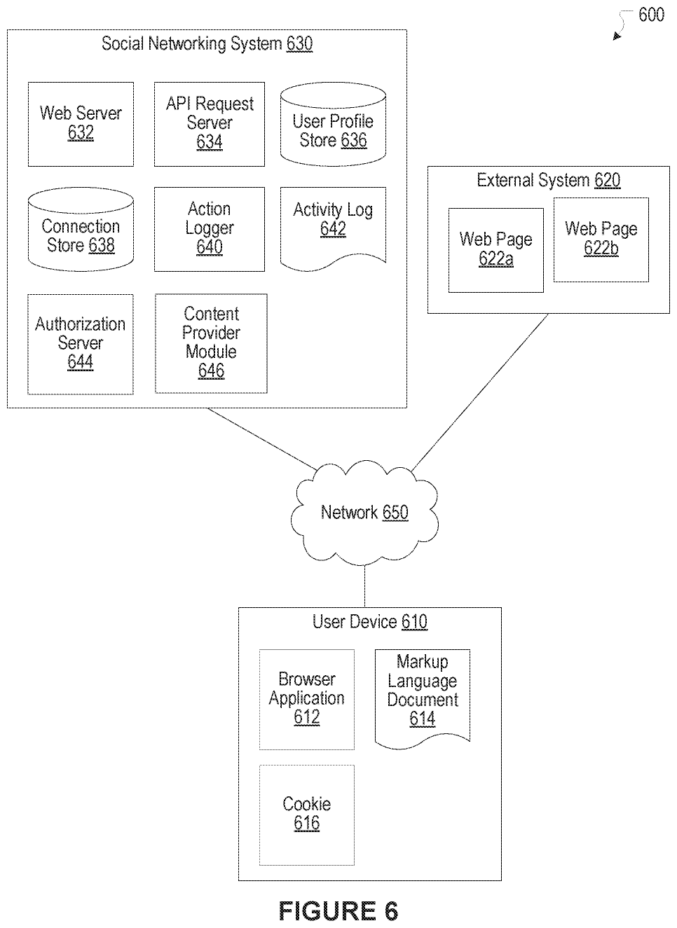

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be, in part or in whole, implemented as software running on one or more computing devices or systems, such as on a server system or a client computing device. In some instances, the content provider module 102 can be, in part or in whole, implemented within or configured to operate in conjunction with or be integrated with a social networking system (or service), such as a social networking system 630 of FIG. 6. Likewise, in some instances, the content provider module 102 can be, in part or in whole, implemented within or configured to operate in conjunction with or be integrated with a client computing device, such as the user device 610 of FIG. 6. For example, the content provider module 102 can be implemented as or within a dedicated application (e.g., app), a program, or an applet running on a user computing device or client computing system. The application incorporating or implementing instructions for performing functionality of the content provider module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The content provider module 102 can be configured to communicate and/or operate with the at least one data store 114, as shown in the example system 100. The data store 114 can be configured to store and maintain various types of data. In some implementations, the data store 114 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 114 can store information that is utilized by the content provider module 102. For example, the data store 114 can store user data, advertisement data, user-advertisement interaction data, one or more machine learning models, and the like. It is contemplated that there can be many variations or other possibilities.

The content module 104 can be configured to provide users with access to content that is available through a digital content platform, such as a social networking system. In some instances, this content can include content items posted in content feeds accessible through the social networking system, i.e., content posts. For example, the content module 104 can provide a first user with access to content posts through an interface that is provided by a software application (e.g., a social networking application) running on a computing device of the first user. The first user can also interact with the interface to post content posts to the social networking system. Such content posts may include text, images, audio, and videos, to name some examples. For example, the first user can submit a content post to be published through the social networking system. In some embodiments, the content post can include, or reference, one or more media content items, such as images, video, audio, and/or text.

In various embodiments, other users of the social networking system can access content posts posted by the first user. In one example, the other users can access the content posts by searching for the first user by user name through an interface provided by a software application (e.g., a social networking application, browser, etc.) running on their respective computing devices. In some instances, some users may want to see content posts posted by the first user in their respective content feed. To cause content posts posted by the first user to be included in their respective content feed, a user can select an option through the interface to subscribe to, or “follow”, the first user. The follow module 106 can process the user's request by identifying the user as a follower of (or “friend” of) the first user in the social networking system. As a result, some or all content posts that are posted by the first user can automatically be included in the respective content feed of the user. If the user decides that they no longer want to see content from the first user in their respective content feed, the user can select an option through the interface to unsubscribe from, or “unfollow”, the first user. As a result, the follow module 106 can remove the association between the user and the first user so that content posts posted by the first user are no longer included in the content feed of the user.

In some instances, users may want to interact with content posts posted to a social networking system. For example, a user may want to endorse, or “like”, a content post. In this example, the user can select an option provided in the interface to like the desired content post. The interaction module 108 can determine when a user likes a given content post and can store information describing this relationship. The interaction module 108 can also determine when other forms of user interaction are performed and can store information describing the interaction (e.g., information describing the type of interaction, the identity of the user, the identity of the user that posted the content post, and the content post, to name some examples). For example, the user may want to post a comment in response to a content post. In this example, the user can select an option provided in the interface to enter and post the comment for the desired content post. The interaction module 108 can determine when a user posts a comment in response to a given content post and can store information describing this relationship. Other forms of user interaction can include emoji-based reactions to a content post (e.g., selecting an option that corresponds to a particular reaction emoji, e.g., happy, sad, angry, etc.), re-sharing a content post, and transmitting a message to a user pertaining to a particular content post, for example.

In some embodiments, the story module 110 can provide an option that allows users to post their content as stories. In such embodiments, each user has a corresponding story collection in which the user can post content. When a user's story collection is accessed by another user, the story module 110 can provide content posted in the story collection to the other user for viewing. In certain embodiments, each user can have a story feed in which they can view stories posted by other users to their respective story collections. As such, a user's story feed can include the story collections of one or more users (e.g., one or more users that the user follows). In some embodiments, content posted in a user's story collection may be accessible by any user of the social networking system. In some embodiments, content posted in a user's story collection may only be accessible to followers of the user. In some embodiments, user stories posted to a user's story collection expire after a pre-defined time interval (e.g., every 24 hours). In such embodiments, content posted as a story in a story collection is treated as ephemeral content that is made inaccessible once the pre-defined time interval has elapsed. In contrast, content posted in certain other content feeds, such as a user (or follower) primary content feed, can be treated as non-ephemeral content that remains accessible for a longer and/or an indefinite period of time.

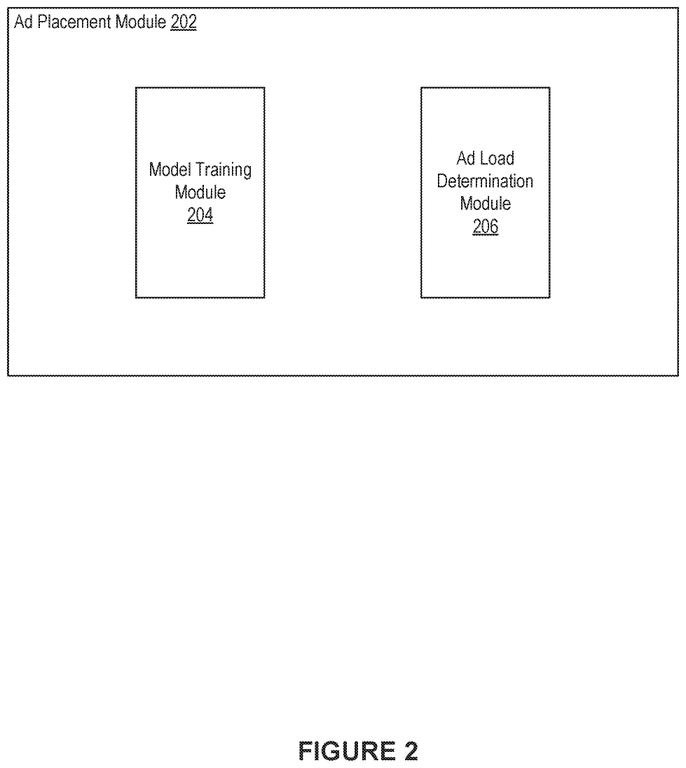

The ad placement module 112 can be configured to dynamically place advertisements within user content feeds amongst other organic, non-advertisement content. In various embodiments, one or more machine learning models can be trained to determine, for each user, an optimal or preferred ad load. In an embodiment, multiple machine learning models can be trained, with each machine learning model being associated with a particular ad load. Each machine learning model can be trained to receive a set of user features for a particular user, and to output a predicted user satisfaction score. A predicted user satisfaction score determined by a machine learning model associated with a particular ad load can be indicative of a user's predicted satisfaction with a content platform if the user is presented with advertisements in accordance with that particular ad load. For a particular user, predicted user satisfaction scores can be calculated using each machine learning model of the plurality of machine learning models. An optimal or preferred ad load can be selected for the user based on the predicted user satisfaction scores. More details regarding the ad placement module 112 will be provided below with reference to FIG. 2.

FIG. 2 illustrates an example ad placement module 202 configured to dynamically place advertisements within user content feeds, according to an embodiment of the present technology. In some embodiments, the ad placement module 112 of FIG. 1 can be implemented as the ad placement module 202. As shown in the example of FIG. 2, the ad placement module 202 can include a model training module 204 and an ad load determination module 206.

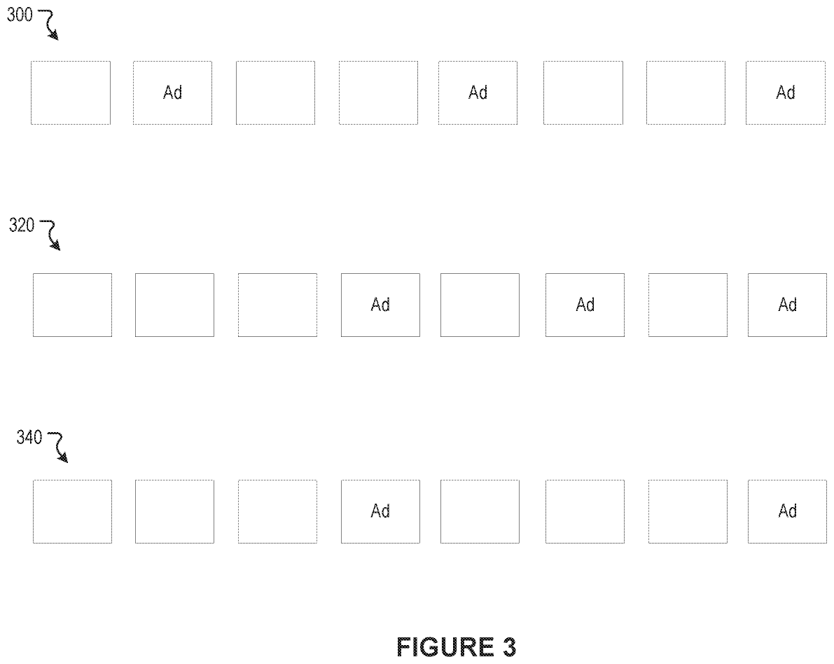

The model training module 204 can be configured to train one or more machine learning models for dynamic placement of advertisements in content feeds. In an embodiment, the model training module 204 can be configured to train one or more machine learning models for dynamic placement of advertisements in a story feed. In an embodiment, the one or more machine learning models can be trained to determine an optimal or preferred ad load for a user. An ad load may specify how frequently users are to be presented with advertisements. For example, a first ad load may specify that a user is to be presented with an advertisement for every three organic content items (e.g., every three organic stories), while a second ad load may specify that a user is to be presented with an advertisement for every five organic content items. Ad loads may have varying levels of specificity. For example, an ad load may specify a particular position for a first advertisement (e.g., a first advertisement after x organic content items), and then repeating positions for subsequent advertisements (e.g., subsequent advertisements to be presented after every y organic content items). Many variations are possible. Three different examples of ad loads are presented in FIG. 3. A first ad load 300 specifies that a first advertisement is presented after one organic content item, and subsequent advertisements are presented after every two organic content items. A second ad load 320 indicates that a first advertisement is presented after three organic content items, and subsequent advertisements are presented after every one organic content item. A third ad load 340 indicates that advertisements are presented after every three organic content items.

In various embodiments, and as will be described in greater detail below, the one or more machine learning models trained by the model training module 204 can be utilized to determine an appropriate ad load for a user that will maximize user satisfaction and/or maintain a threshold level of user satisfaction. In order to do this, user satisfaction must be quantified in some manner. In an embodiment, for each user of a set of users, a user satisfaction score can be calculated. The user satisfaction score may be a combination (e.g., a weighted combination) of one or more user satisfaction metrics. The one or more user satisfaction metrics may be selected based on how indicative they are of a user's satisfaction with a digital content platform, such as a social networking system. For example, various examples of user satisfaction metrics can include overall time spent on the digital content platform (e.g., time spent on the platform per day, or over the course of a week, or a month), time spent using one or more features of the platform (e.g., time spent each day using camera filters or other AR filters), rate of interaction with content on the platform (e.g., interactions per content item viewed), advertisement click-through rate (e.g., clicks and/or interactions per advertisement viewed), user satisfaction survey results, and the like. The set of user satisfaction metrics can be combined into a single user satisfaction score (e.g., a score between 0 and 1) indicative of a user's satisfaction with the digital content platform. For example, a user satisfaction score of 0 may indicate that a user is completely dissatisfied with the digital content platform, and a user satisfaction score of 1 may indicate that the user is completely satisfied.

In an embodiment, the model training module 204 can identify a set of users from which to collect training data for training the one or more machine learning models. The training data can include a plurality of training data instances. Each training data instance may be associated with a respective user of the set of users, and can be labeled with a user satisfaction score calculated for the user. In order to obtain the training data for training the one or more models, each user in the set of users can be observed over a period of time (i.e., an observation period). In one embodiment, during the observation period, each user can be presented with advertisements according to a particular ad load. Different users may be presented with advertisements according to different ad loads, but for each individual user, the ad load may be kept consistent over the course of the observation period.

For each user of the set of users, at the end of an observation period, a user satisfaction score can be calculated for the user based on user satisfaction metrics observed for the user over the observation period. Furthermore, training feature data can be collected. Training feature data can include any types of information that may be useful for predicting user satisfaction with a digital content platform based on the number of advertisements presented to the user. For example, training feature data can include user features, such as demographic features (e.g., age, gender, country/state/city of residence), user interest information, and the like. Training feature data can also include advertisement features for advertisements presented to a user during an observation period. Advertisement features can include, for example, an ad load selected for the user during the observation period, what types of ad formats were presented to the user during the observation period (e.g., video ads, image ads), the content of ads presented to the user during the observation period (e.g., types of products/services being advertised, brands being advertised), interaction metrics for the particular ads presented to the user during the observation period (e.g., historical click-through rate for each advertisement), and the like. Training feature data can also include user-ad interaction features indicative of how the particular user has historically interacted with advertisements and/or how the user interacted with advertisements during the observation period. For example, user-ad interaction features for a user can include the user's historical click-through rate on advertisements, the user's historical exit rate (i.e., x-out rate) on advertisements, the user's historical click-through rate for particular types of advertisements (e.g., for advertisements associated with particular categories of products/services, or particular brands), and the like.

A training data instance may be defined based on a set of training feature data collected for a user, and the training data instance can be labeled using a user satisfaction score calculated for the user. By collecting this information for each user in the set of users, the model training module 204 can collect a set of training data comprising a set of training instances. The training data can be used to train one or more machine learning models. Using the data described above, the one or more machine learning models can be trained to determine how various user characteristics affect user satisfaction (e.g., how they affect a user satisfaction score). As such, the one or more machine learning models can be trained to calculate, given a set of user characteristics, a predicted user satisfaction score indicative of a user's predicted satisfaction with a digital content platform if the user is presented with advertisements according to a particular ad load.

In an embodiment, each machine learning model of the one or more machine learning models may be associated with a particular ad load. For example, a first machine learning model may be associated with a first ad load in which users are presented with an ad every 10 organic content items, while a second machine learning model may be associated with a second ad load in which users are presented with an ad every 7 organic content items, and so forth. Each machine learning model may be configured to receive a set of user features associated with a user, and to determine a predicted user satisfaction score based on the set of user features. The predicted user satisfaction score calculated for a particular user by a particular machine learning model associated with a particular ad load may be indicative of the particular user's predicted satisfaction if the user is presented with advertisements in accordance with the particular ad load. As such, each machine learning model, when presented with the same set of user features, may output different predicted user satisfaction scores because each machine learning model is predicting a user satisfaction score for a different ad load.

The ad load determination module 206 can be configured to determine an optimal ad load for a user based on user features associated with the user and one or more machine learning models. As described above, the model training module 204 can train one or more machine learning model. Each machine learning model may be associated with a respective ad load of a plurality of ad loads. Each machine learning model can also be configured to determine a predicted user satisfaction score for a user based on user features associated with the user. The user features can include any of the user features and/or user-ad interaction features discussed above, such as demographic information (e.g., age, gender, country/state/city of residence), user interest information, the user's historical click-through rate on advertisements, the user's historical exit rate (i.e., x-out rate) on advertisements, the user's historical click-through rate for particular types of advertisements (e.g., for advertisements associated with particular categories of products/services, or particular brands), and the like. In certain embodiments, each machine learning model may also be configured to receive advertisement features for one or more candidate advertisements to be presented to the user, and can determine a predicted user satisfaction score based on the user features and the advertisement features. The advertisement features can include, for example, the types of ads that may be presented to the user (e.g., video ads, image ads), the content of ads that may be presented to the user (e.g., types of products/services being advertised, brands being advertised), historical interaction metrics for the candidate ads (e.g., historical click-through rate for each advertisement), and the like.

As discussed above, each machine learning model of a plurality of machine learning models may be associated with a respective ad load of a plurality of ad loads. For example, a first machine learning model may be associated with a first ad load, a second machine learning model may be associated with a second ad load, a third machine learning model may be associated with a third ad load, and so forth. User features for a particular user (and, in some embodiments, advertisement features for a set of candidate advertisements that may be presented to the user) can be provided to each machine learning model of the plurality of machine learning models. Each machine learning model can output a predicted user satisfaction score based on the user features and/or the advertisement features, resulting in a plurality of predicted user satisfaction scores. Of the plurality of predicted user satisfaction scores, a highest predicted user satisfaction score can be identified. The machine learning model that resulted in the highest predicted user satisfaction score can also be identified, and an ad load associated with that machine learning model can be selected as the optimal ad load for the user. Advertisements can then be presented to the user in accordance with the identified optimal ad load. For example, advertisements may be presented within the user's story feed in accordance with the identified optimal ad load.

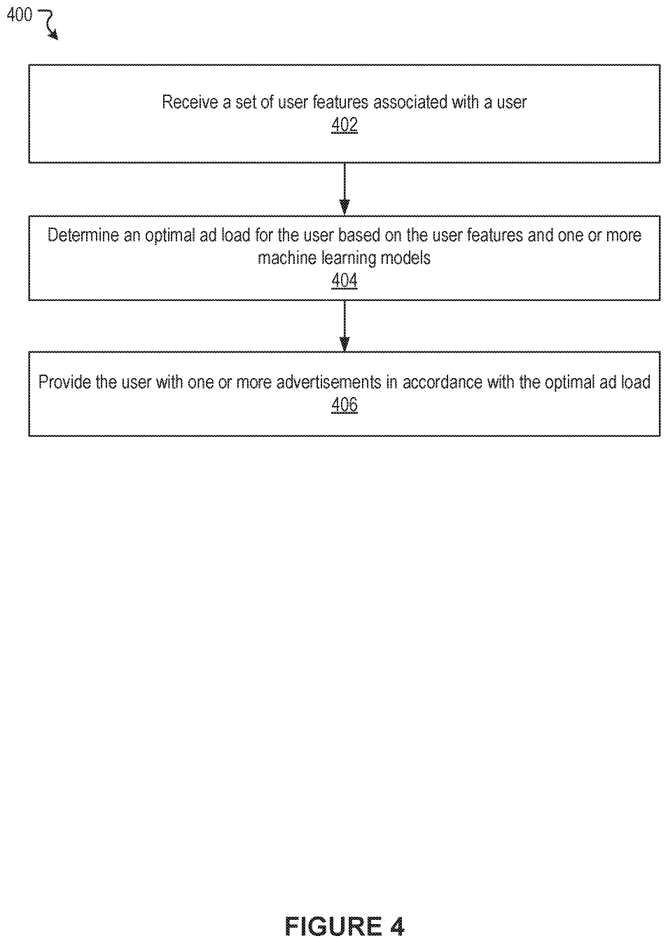

FIG. 4 illustrates an example method 400, according to an embodiment of the present technology. It should be appreciated that there can be additional, fewer, or alternative steps performed in similar or alternative orders, or in parallel, within the scope of the various embodiments discussed herein unless otherwise stated.

At block 402, the example method 400 can receive a set of user features associated with a user. At block 404, the example method 400 can determine an optimal ad load for the user based on the user features and one or more machine learning models. At block 406, the example method 400 can provide the user with one or more advertisements in accordance with the optimal ad load.

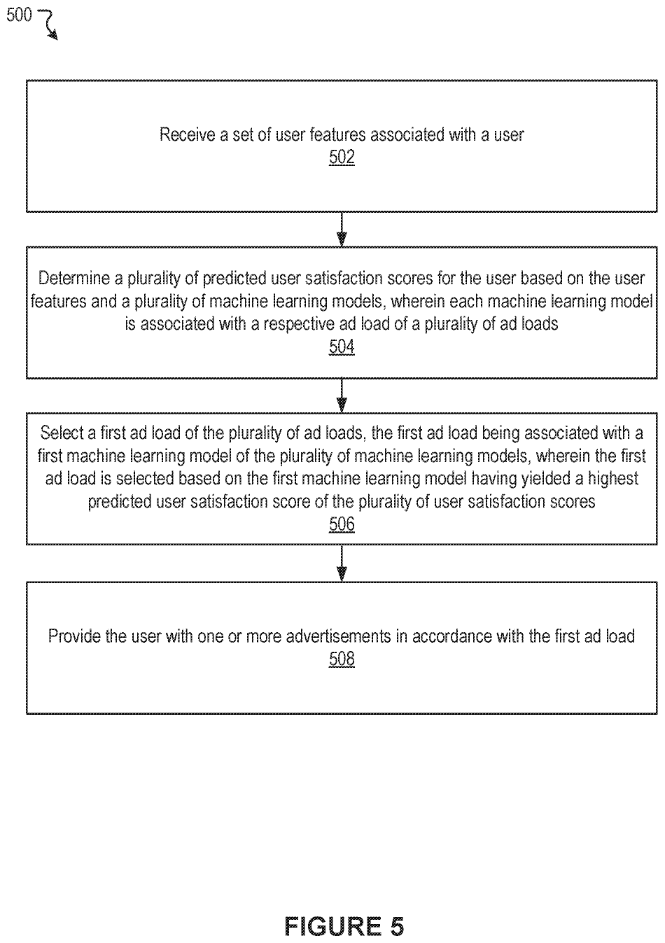

FIG. 5 illustrates an example method 500, according to an embodiment of the present technology. It should be appreciated that there can be additional, fewer, or alternative steps performed in similar or alternative orders, or in parallel, within the scope of the various embodiments discussed herein unless otherwise stated.

At block 502, the example method 500 can receive a set of user features associated with a user. At block 504, the example method 500 can determine a plurality of predicted user satisfaction scores for the user based on the user features and a plurality of machine learning models, wherein each machine learning model is associated with a respective ad load of a plurality of ad loads. At block 506, the example method 500 can select a first ad load of the plurality of ad loads, the first ad load being associated with a first machine learning model of the plurality of machine learning models, wherein the first ad load is selected based on the first machine learning model having yielded a highest predicted user satisfaction score of the plurality of predicted user satisfaction scores. At block 508, the example method 500 can provide the user with one or more advertisements in accordance with the first ad load.

It is contemplated that there can be many other uses, applications, and/or variations associated with the various embodiments of the present technology. For example, in some cases, user can choose whether or not to opt-in to utilize the disclosed technology. The disclosed technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102, as discussed in more detail herein. As discussed previously, it should be appreciated that there can be many variations or other possibilities. For example, in some embodiments, one or more functionalities of the content provider module 646 can be implemented in the user device 610. As discussed previously, it should be appreciated that there can be many variations or other possibilities.

### Hardware Implementation

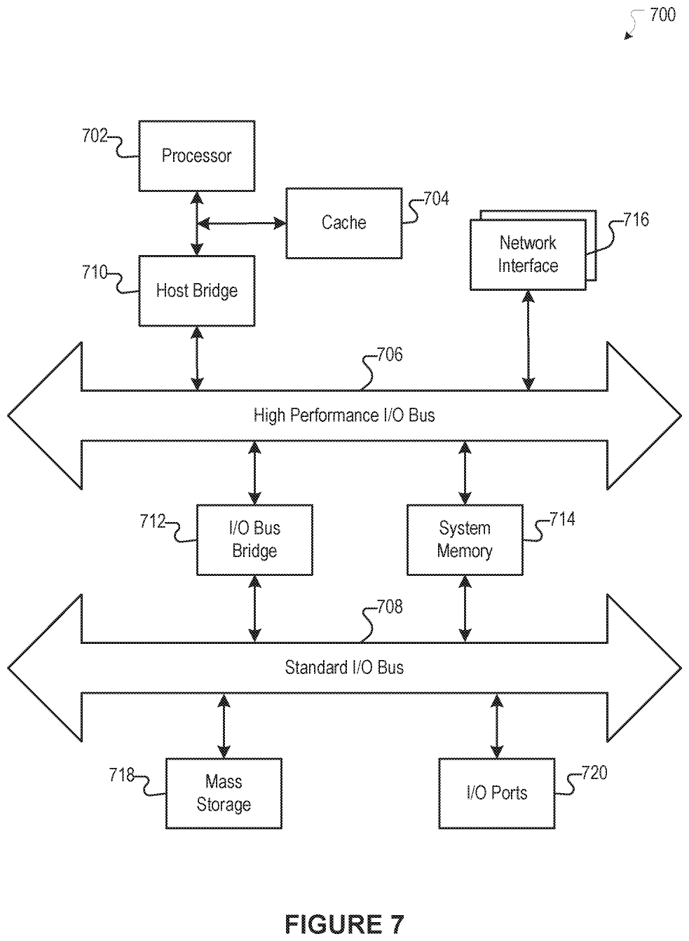

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, a set of user features associated with a user;
determining, by the computing system, an optimal ad load for the user based on the set of user features and one or more machine learning models; and
providing, by the computing system, the user with one or more advertisements in accordance with the optimal ad load.

2. The computer-implemented method of claim 1, wherein the determining the optimal ad load for the user based on the set of user features and one or more machine learning models comprises selecting an optimal ad load for the user from a plurality of ad loads based on the set of user features and a plurality of machine learning models.

3. The computer-implemented method of claim 2, wherein each machine learning model of the plurality of machine learning models is associated with a respective ad load of the plurality of ad loads.

4. The computer-implemented method of claim 3, wherein the selecting the optimal ad load for the user based on the set of user features and the plurality of machine learning models comprises determining a plurality of predicted user satisfaction scores for the user based on the set of user features and the plurality of machine learning models, and further wherein each predicted user satisfaction score of the plurality of user satisfaction scores is associated with a respective machine learning model of the plurality of machine learning models.

5. The computer-implemented method of claim 4, wherein the selecting the optimal ad load for the user based on the set of user features and the plurality of machine learning models further comprises selecting a first ad load of the plurality of ad loads as the optimal ad load for the user, the first ad load being associated with a first machine learning model of the plurality of machine learning models, and further wherein the first ad load is selected as the optimal ad load for the user based on the first machine learning model having yielded a highest predicted user satisfaction score of the plurality of user satisfaction scores.

6. The computer-implemented method of claim 1, wherein the set of user features comprises demographic information for the user.

7. The computer-implemented method of claim 1, wherein the set of user features comprises historical user-ad interaction information for the user.

8. The computer-implemented method of claim 1, further comprising receiving a set of advertisement features for one or more candidate advertisements that may be presented to the user.

9. The computer-implemented method of claim 8, wherein the determining the optimal ad load for the user based on the set of user features and one or more machine learning models comprises determining an optimal ad load for the user based on the set of user features, the set of advertisement features, and the one or more machine learning models.

10. The computer-implemented method of claim 9, wherein the set of advertisement features comprise historical click-through rates for the one or more candidate advertisements.

11. A system comprising:
at least one processor; and
a memory storing instructions that, when executed by the at least one processor, cause the system to perform a method comprising:
receiving a set of user features associated with a user;
determining an optimal ad load for the user based on the set of user features and one or more machine learning models; and
providing the user with one or more advertisements in accordance with the optimal ad load.

12. The system of claim 11, wherein the determining the optimal ad load for the user based on the set of user features and one or more machine learning models comprises selecting an optimal ad load for the user from a plurality of ad loads based on the set of user features and a plurality of machine learning models.

13. The system of claim 12, wherein each machine learning model of the plurality of machine learning models is associated with a respective ad load of the plurality of ad loads.

14. The system of claim 13, wherein the selecting the optimal ad load for the user based on the set of user features and the plurality of machine learning models comprises determining a plurality of predicted user satisfaction scores for the user based on the set of user features and the plurality of machine learning models, and further wherein each predicted user satisfaction score of the plurality of user satisfaction scores is associated with a respective machine learning model of the plurality of machine learning models.

15. The system of claim 14, wherein the selecting the optimal ad load for the user based on the set of user features and the plurality of machine learning models further comprises selecting a first ad load of the plurality of ad loads as the optimal ad load for the user, the first ad load being associated with a first machine learning model of the plurality of machine learning models, and further wherein the first ad load is selected as the optimal ad load for the user based on the first machine learning model having yielded a highest predicted user satisfaction score of the plurality of user satisfaction scores.

16. A non-transitory computer-readable storage medium including instructions that, when executed by at least one processor of a computing system, cause the computing system to perform a method comprising:
receiving a set of user features associated with a user;
determining an optimal ad load for the user based on the set of user features and one or more machine learning models; and
providing the user with one or more advertisements in accordance with the optimal ad load.

17. The non-transitory computer-readable storage medium of claim 16, wherein the determining the optimal ad load for the user based on the set of user features and one or more machine learning models comprises selecting an optimal ad load for the user from a plurality of ad loads based on the set of user features and a plurality of machine learning models.

18. The non-transitory computer-readable storage medium of claim 17, wherein each machine learning model of the plurality of machine learning models is associated with a respective ad load of the plurality of ad loads.

19. The non-transitory computer-readable storage medium of claim 18, wherein the selecting the optimal ad load for the user based on the set of user features and the plurality of machine learning models comprises determining a plurality of predicted user satisfaction scores for the user based on the set of user features and the plurality of machine learning models, and further wherein each predicted user satisfaction score of the plurality of user satisfaction scores is associated with a respective machine learning model of the plurality of machine learning models.

20. The non-transitory computer-readable storage medium of claim 19, wherein the selecting the optimal ad load for the user based on the set of user features and the plurality of machine learning models further comprises selecting a first ad load of the plurality of ad loads as the optimal ad load for the user, the first ad load being associated with a first machine learning model of the plurality of machine learning models, and further wherein the first ad load is selected as the optimal ad load for the user based on the first machine learning model having yielded a highest predicted user satisfaction score of the plurality of user satisfaction scores.
